(19) United States
(12) Patent Application Publication
(10) Pub. No.: US 2026/0250019 A1
(43) Pub. Date: Aug. 27, 2026

(54) MAGNETIC VEHICLE ASSEMBLY AND METHODS THEREOF

(71) Applicant: Supernal, LLC, Irvine, CA (US)

(72) Inventor: Robert Lee JACKSON, Rossmoor, CA (US)

(73) Assignee: Supernal, LLC, Irvine, CA (US)

(21) Appl. No.: 19/541,869

(22) Filed: Feb. 17, 2026

Related U.S. Application Data
(60) Provisional application No. 63/764,246, filed on Feb. 27, 2025.

(51) Int. Cl. B64F 5/10; H01F 7/02

(52) U.S. Cl. CPC B64F 5/10; H01F 7/0252

(57) ABSTRACT

A method for assembling a vehicle is provided. The method includes: applying a first set of magnets to a first set of predefined positions on a first surface of a first structural component of the vehicle; applying a second set of magnets to a second set of predefined positions on a first surface of a second structural component of the vehicle; preparing a second surface of the first structural component for bonding the first structural component to the second structural component; applying a bonding material to the prepared second surface of the first structural component; positioning a second surface of the second structural component against the bonding material on the prepared second surface of the first structural component; and removing the first set of magnets from the first surface of the first structural component and the second set of magnets from the first surface of the second structural component.

### CROSS REFERENCE TO RELATED APPLICATIONS

This application claims priority to U.S. Provisional Application No. 63/764,246 filed Feb. 27, 2025, which is incorporated by referenced herein its entirety.

### TECHNICAL FIELD

Aspects of the present disclosure relate generally to structural assembly methods and tools and, more particularly, to methods and tools that utilize magnets for precise component placement and bonding in assembling objects, such as vehicles.

### BACKGROUND

In traditional aircraft manufacturing, extensive assembly jigs, pilot holes, and fasteners are typically required to hold parts in precise locations for bonding or fastening. The alignment process often necessitates drilling holes for fasteners, which not only increases labor but also introduces potential stress points. Existing solutions can be costly, time-intensive, and inflexible, particularly when changes in engineering specifications arise. Neodymium rare earth magnets are widely used in various industries due to their high strength and compact size. Although not commonly used in aircraft assembly, their ability to provide a significant holding force without permanent attachments opens up new potential for tool less, precise, and adaptable assembly processes.

The present disclosure is accordingly directed to a method for assembling aircraft structural components by utilizing strategically placed neodymium rare earth magnets on the external and internal parts of a structure to achieve precise alignment without the need for invasive fasteners or large jigs. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, rare earth magnets are disclosed that may be utilized in a vehicle assembly process.

In one aspect, a method for assembling a vehicle is provided. The may include: applying a first set of magnets to a first set of predefined positions on a first surface of a first structural component of the vehicle; applying a second set of magnets to a second set of predefined positions on a first surface of a second structural component of the vehicle; preparing a second surface of the first structural component, opposite the first surface of the first structural component, for bonding the first structural component of the vehicle to the second structural component of the vehicle; applying a bonding material to the prepared second surface of the first structural component; positioning a second surface of the second structural component against the applied bonding material on the prepared second surface of the first structural component, wherein the second structural component is secured against the first structural component via a magnetic attraction formed between the first set of magnets and the second set of magnets; and removing, after a predetermined cure time associated with the bonding material, the first set of magnets from first surface of the first structural component and the second set of magnets from the first surface of the second structural component.

In another aspect, a magnet assembly is provided. They magnet assembly may include: a first portion including a first surface and a second surface, the second surface positioned opposite the first surface; each of the first surface and the second surface, including: an engagement pad positioned proximate to a first end of the first portion; and one or more protruding nodes; a second portion connected to a second end of the first portion; and a magnet encased within a housing of the second portion.

In yet another aspect, a method for assembling a vehicle is disclosed. The method may include: placing a first set of magnets at a first set of predefined positions on a first surface of a first structural component of the vehicle utilizing at least one robotic component; placing a second set of magnets at a second set of predefined positions on a first surface of a second structural component of the vehicle utilizing at least one robotic component; preparing, with the at least one robotic component, a bonding surface for bonding the first structural component of the aircraft to the second structural component of the vehicle; distributing, using the at least one robotic component, an adhesive along the bonding surface; and positioning, using the at least one robotic component, the second structural component against the bonding surface such that magnetic forces align the first structural component with the second structural component.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate the disclosed embodiments, and, together with the description, serve to explain the principles of the disclosed embodiments. There are many aspects and embodiments described herein.

FIG. 1 depicts an exemplary workflow for assembling aircraft structures using magnets, according to one or more aspects of the present disclosure.

FIG. 2 depicts a schematic representation of an aircraft structure assembled with magnets, according to one or more aspects of the present disclosure.

FIG. 3A depicts a perspective view of a magnet assembly designed for robotic automation of aircraft assembly, according to one or more aspects of the present disclosure.

FIG. 3B depicts a side view of the magnet assembly in FIG. 3A, according to one or more aspects of the present disclosure.

### DETAILED DESCRIPTION OF THE EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, article or apparatus that comprises a list of elements does not necessarily include only those elements, and may include other elements not expressly listed or inherent to such a process, method, article, or apparatus. Relative terms, such as “about,” “approximately,” “substantially,” and “generally,” are used to indicate a possible variation of ±10% of a stated or understood value. In addition, the term “between” used in describing ranges of values is intended to include the minimum and maximum values described in that range. The use of the term “or” in the claims and specification is used to mean “and/or” unless either explicitly indicated to refer to alternatives only or the alternatives are mutually exclusive, although the disclosure supports a definition that refers to only alternatives and “and/or.” As used herein “another” may mean at least a second or more.

As used herein, the term “vehicle” may refer to any type of vehicle, e.g., motor vehicles (e.g., cars, trucks, buses, etc.), railed vehicles (e.g., trains, etc.), waterborne vessel (e.g., boats, etc.), aircraft (e.g., planes, helicopters, etc.), spacecraft, autonomous or semi-autonomous vehicles, and the like. Various embodiments of the present disclosure relate generally to electric vehicles, such as vehicles driven via one or more electric loads, components associated with the electrical loads, and monitoring systems for the electrical loads and/or the components associated with the electrical loads. The electric loads may be in the form of electric motors associated with one or more propellers of a vertical takeoff and landing vehicle.

The assembly of aircraft structural components, particularly large composite structures like fuselage sections and internal frames, requires precision, strength, and reliability to ensure the structural integrity of the aircraft. Traditional aircraft manufacturing methods often rely on extensive jigs, pilot holes, and fasteners (e.g., Cleco pins) to align components precisely during bonding. These fasteners may be used to hold parts in place while adhesives cure, ensuring that critical components like frames or ribs stay aligned and securely bonded to the outer skin or fuselage. However, this approach introduces several issues. First, the reliance on drilling pilot holes for fasteners compromises the integrity of composite materials, such as carbon fiber reinforced polymer (CFRP), which are increasingly used for their lightweight and high-strength properties. Holes in these materials create stress concentrations that can weaken the structure, reduce durability, and necessitate additional reinforcement. Furthermore, large assembly jigs are costly, occupy significant space, and lack flexibility, making it difficult to adapt the manufacturing process to design changes or different aircraft models without extensive reconfiguration. The lead times for producing and modifying these jigs also add to the overall time and expense of the manufacturing process.

To address these challenges, various conventional attempts have been made to reduce dependency on jigs and fasteners. For example, some manufacturers have experimented with modular assembly fixtures, or less invasive temporary bonding aids. However, these solutions have limitations in terms of precision, adaptability, and cost. For instance, modular fixtures may be reconfigured but are still expensive and bulky, limiting the space around the aircraft for other tools or automated systems. Additionally, modular fixtures may be limited to the extent that they may be reconfigured. Temporary bonding aids often lack the strength needed to hold large, heavy components securely during curing, especially in complex, curved assemblies. As a result, traditional methods still dominate, despite their limitations, due to the absence of an effective, adaptable alternative.

The concepts described herein address the issues described above by providing a novel, toolless solution for aircraft structural assembly by leveraging the power of magnets, e.g., such as neodymium rare earth magnets, to align and hold components in place without fasteners or large jigs. More particularly, the novel concepts involve the strategic placement of magnets on the outer surface of the fuselage and the internal components (e.g., such as the frames) to create a magnetic force that aligns and secures the components for bonding. The magnets provide the necessary preload to keep parts in position during the adhesive curing process, thereby replacing the need for mechanical fasteners or jigs. By using robotic arms to place these magnets with precision, the process may achieve highly accurate alignment, which is important for structural components in aircraft. This concept allows the robotic arms to perform tasks like surface preparation, adhesive application, and component alignment without needed to hold the part in place throughout the curing process, increasing efficiency and reducing manufacturing time.

The concepts described herein address the issues faced by conventional methods in several ways. For instance, the novel processes eliminate the need for drilling pilot holes in composite materials, preserving the structural integrity of the CFRP and similar non-ferrous (e.g., nonmagnetic) materials. By avoiding invasive fasteners, this approach reduces stress concentrations, thereby improving the durability and lifespan of the components. Additionally, the elimination of large assembly jigs frees up valuable space around the aircraft, allowing more room for robotic arms and other automated systems to access and assemble components, which enhances overall manufacturing flexibility. The use of neodymium magnets for precise alignment also makes the process highly adaptable to design changes, as adjustments to magnet placement can be easily programmed into the robotic arms, minimizing lead times associated with tooling modifications. Furthermore, by relying on magnetic force to achieve and maintain alignment, the system provides a reliable and repeatable method that can be automated, ensuring consistency in production and reducing dependency on manual labor.

Reference will now be made in detail to the exemplary embodiments of the present disclosure described below and illustrated in the accompanying drawings. Wherever possible, the same reference numbers will be used throughout the drawings to refer to same or like parts.

Additional objects and advantages of the embodiments will be set forth in part in the description that follows, and in part will be obvious from the description, or may be learned by practice of the embodiments. It is to be understood that both the foregoing general description and the following detailed description are exemplary and explanatory only and are not restrictive of the claims. For simplicity purposes, the vehicle in the remaining disclosure described herein, and the figures associated therewith, is an electric powered vertical take-off and landing (VTOL) aircraft. However, such a designation is not limiting, and the concepts described herein may be applicable to virtually any type of vehicle.

Additionally to the foregoing, although neodymium rare earth magnets are primarily discussed herein as the objects which may align and hold components in place during aircraft assembly, such a designation is not limiting. More particularly, other materials with similar characteristics may also be used in the disclosed processes, such as samarium-cobalt (SmCo) magnets, ferrite magnets, Alnico magnets, electromagnets, magnetically loaded adhesives, and the like.

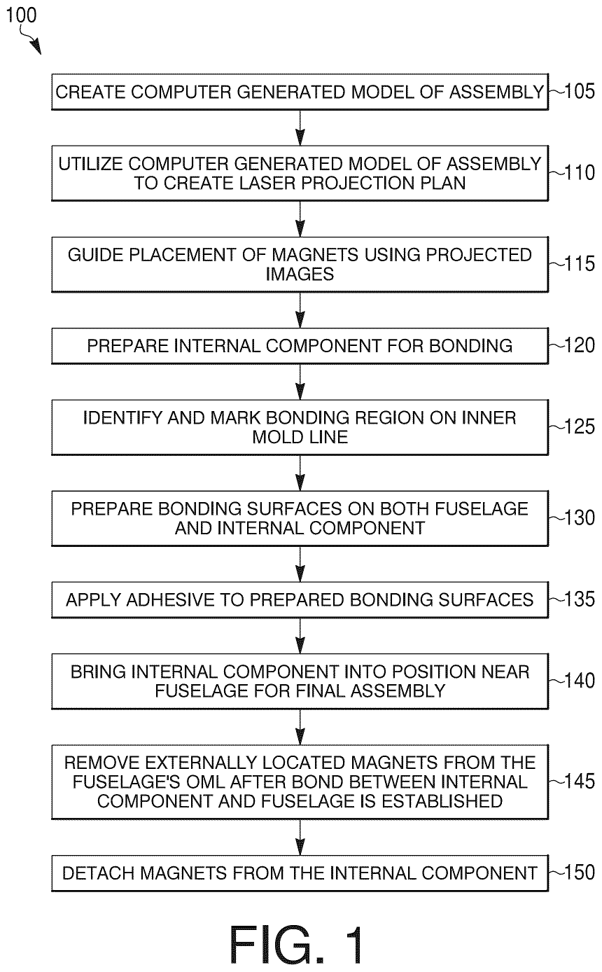

Referring now to FIG. 1, an exemplary workflow 100 is described for assembling primary aircraft structures using magnets (e.g., neodymium rare earth magnets) for precise alignment and bonding. Although described chronologically, some steps in workflow 100 may be performed simultaneously, or in a different order than FIG. 1 illustrates. Further, workflow 100 may include other or additional steps. For instance, steps directed to the preparation and placement of magnets on the fuselage may occur simultaneously in some instances with the preparation and placement of magnets on an internal component.

At step 105, computer software may be utilized to create a detailed computer-generated model (“model”) of the assembly. This model may include the primary structural components of the aircraft, such as the fuselage and the internal elements that need to be precisely positioned and bonded within the fuselage (e.g., frames, stringers, etc.). In an aspect, the model may not only help to visualize the assembly, but may also serve as a blueprint for exact placement of the magnets that will be used as the primary alignment and holding mechanism during assembly. In this regard, every magnet's location may be carefully specified within the CAD environment to ensure that when placed, these magnets will draw the components into precise alignment. This is particularly important for large and complex structures like an aircraft fuselage, where minor misalignments may lead to structural weakness or affect aerodynamics.

In an aspect, the model may take into account the dimensions, tolerances, and/or bonding areas of each component, ensuring that the magnets are positioned to provide the necessary preload for bonding without affecting the material integrity of each component. In some aspects, software associated with the model may enable users to simulate the alignment process, predicting how each magnet's position will affect the component's fit within the fuselage and identifying any potential issues in advance. This may therefore reduce the margin for error when physical components are later assembled on the manufacturing floor.

At step 110, the model generated in step 105 may be utilized to create a laser projection plan that precisely marks the locations where each magnet should be placed on the outer mold line (OML) of the fuselage, or the parent part. More particularly, the laser projection plan may translate the CAD-defined coordinates into a visual guide, allowing a laser projection to display the exact magnet positions on the physical fuselage surface. In an aspect, the laser projection may act as a blueprint, illuminating the footprint of each magnet directly onto the fuselage's OML. This projection may minimize, or eliminate, the guesswork, or imprecision, that may arise from manual measurement, ensuring each magnet's placement matches the model's specifications with precision. The accuracy of this projection is especially important in aircraft manufacturing, where minor discrepancies in alignment may compromise the structural integrity or aerodynamic efficiency of the final assembly.

In an aspect, before magnets are adhered, a protective layer of material may be applied to the surface of the fuselage in the areas where the magnets will be placed. This protective layer may serve multiple purposes. For instance, the protective layer may: prevent any potential damage or residue left by the temporary adhesive, preserve the surface finish of the fuselage, and/or ensure easy removal of the magnets after bonding is complete. For materials like carbon fiber reinforced polymer, which is commonly utilized in fuselage structures, maintaining the surface integrity is important to avoid compromising the material's performance. Accordingly, this protective layer may also enable the magnets to be applied and removed without causing any harm to the fuselage, which is important for maintaining quality standards in aerospace manufacturing.

At step 115, the locations for each magnet, projected onto the fuselage's OML by the laser guidance system, may be used to guide the placement of the magnets themselves. More particularly, at these locations, a temporary adhesive (e.g., DP 100, Hysol 9394, etc.) may be applied to the fuselage's OML to hold each magnet in place. These adhesives may be chosen for their ability to provide a secure bond during assembly, while still allowing for easy removal after the bonding process is complete. The temporary nature of the adhesives may allow the magnets to be detached cleanly without leaving residue or damaging the fuselage surface. In an aspect, each magnet may be carefully positioned on the adhesive exactly in line with the laser projection, following the CAD-defined coordinates for optimal alignment. This careful placement may ensure that, later in the process, these magnets may interact with corresponding magnets on internal components to pull the internal components into exact alignment with their designated position against the fuselage skin. Accordingly, the magnets serve as both alignment guides and sources of preload, which hold the internal components firmly against the fuselage during the adhesive curing process. By providing this holding force without the need for mechanical fasteners or clamps, the magnets may simplify the assembly process and eliminate the need for invasive fasteners.

At step 120, an internal component that will be bonded to the fuselage may be prepared. In this regard, a shop aid may be leveraged to place the corresponding magnets on the internal component (e.g., such as a frame piece, a stringer, etc.). In an aspect, the shop aid may be a temporary tool or fixture that is used to assist in the precise placement, alignment, or assembly of aircraft structural component during manufacturing. Non-limiting of examples of shop aids may include fixtures, laser projection guides, alignment jigs, etc. This shop aid may be configured to position the magnets at precise locations defined by the CAD model, ensuring that they will line up perfectly with the magnets already placed on the OML of the fuselage. In an aspect, the use of the shop aid may enable consistent and repeatable placement of the magnets on the internal component, eliminating the potential for human error and ensuring that each magnet is aligned to achieve the desired preload and positioning. In an aspect, the shop aid may be adjusted or reconfigured as needed, allowing it to accommodate different components or assembly configurations, further increasing the flexibility of the assembly process. Specifically, by using a reliable reference tool, the magnets may be positioned exactly as dictated by the CAD model, which ensures that the subsequent alignment and bonding are precise and structurally sound. Once the magnets are in place on the internal component, an attraction is created between the external magnets (e.g., those magnets placed on the fuselage's OML) and the internal magnets (e.g., those magnets placed on the internal component) such that as the internal components are moved into position near the fuselage, the magnetic forces may naturally pull it into alignment, thereby eliminating the need for manual adjustments or external clamps.

At step 125, the bonding region(s) on the inner mold line (IML) of the fuselage may be identified and marked. These bonding regions may be locations where the adhesive will be applied to join the internal component to the fuselage. In an aspect, to accurately locate these bonding regions, a specialized shop aid equipped with additional strategically placed magnets may be employed. These additional strategically placed magnets on the shop aid may be positioned to interact with the magnets already affixed to the OML of the fuselage. As the shop aid is brought close to the fuselage, the attraction between the external magnets and the additional shop-aid magnets may allow the shop aid to “self-locate” by aligning automatically with the external magnets, effectively guiding the shop aid into the correct position on the IML. This self-locating ability of the shop aid, facilitated by the magnetic interaction, provides a hands-free, precise way to mark the bonding region without needing manual measurements or adjustments. This magnetic aligning mechanism not only saves time, but also enhances the accuracy and repeatability of the process. In an aspect, once the shop aid is aligned and positioned by the magnets, the shop aid may be used as a reference to mark or identify the exact area on the IML where the adhesive will be applied. This mark ensures that, when the internal component is later brought into position, it aligns seamlessly with the adhesive application, resulting in a strong, uniform bond.

At step 130, the bonding surfaces on both the fuselage and the internal component may be prepared to ensure optimal adhesion and structural integrity in the final assembly. This step produces a strong, reliable bond that will withstand the stresses and environmental conditions encountered by an aircraft in operation. In an aspect, the bond preparation process may include several steps, such as cleaning, abrading, and priming the surfaces, which collectively help to remove any contaminants, such as dust, oils, or other residues, which may compromise the adhesive's ability to bond effectively.

In an aspect, the cleaning process may be the first part of bond preparation and may typically involve utilizing solvents or specialized cleaning agents to remove any surface contaminants, which may interfere with the adhesive's performance, creating weak spots in the bond line. After cleaning, the surfaces may be abraded, or lightly roughened, to enhance the adhesive's grip. This abrasion step increases the surface area available for bonding and creates a texture that allows the adhesive to interlock more securely with the fuselage and internal component. Once cleaned and abraded, the bonding surfaces may then be primed with a bonding agent. Priming is an additional measure that may enhance adhesion, especially when working with composite materials or non-ferrous metals. The primer acts as an intermediary layer between the adhesive and the bonding surfaces, promoting a more uniform and resilient bond. This preparatory layer may also protect the material surface from environmental factors that may weaken the bond over time.

At step 135, the prepared bonding surfaces may be ready for the application of adhesive. The adhesive may be applied along the bonding region that was marked in previous steps. To guarantee that the adhesive layer has the correct thickness, a factor that directly influences bond strength and durability, bond line thickness control measures may be implemented. These measures may include pre-placed spacers, controlled adhesive applicators, or the use of bond line control films, each designed to keep the adhesive layer uniform and within the specified tolerances outlined in the CAD model.

In an aspect, the consistency of the adhesive thickness may be important for structural components where uniform load distribution is critical. More particularly, variations in the bond line may lead to stress concentrations, creating weak spots that may compromise the integrity of the entire assembly. Accordingly, the utilization of an adhesive with bond line thickness control properties may enhance the efficiency of the application process. Some adhesives may be designed to cure to a set thickness, which may help to automatically maintain the specified bond line without needing additional manual adjustments. For instance, controlled-thickness adhesives may incorporate fine glass beads or other microspheres that may act as spacers, preventing the adhesive layer from compressing beyond a certain point during assembly. Additionally or alternatively, robotic systems may be programmed to apply adhesives in a controlled manner, precisely following the contours of the bonding area. This automated approach may minimize human error and ensure that each layer of adhesive is consistent, even on complex or curved surfaces. In an aspect, once the adhesive is applied, it may be carefully spread across the bonding surface, ready for the internal component to be aligned and pressed into position.

At step 140, an internal component (e.g., a frame, a stringer, etc.) may be brought into position near the fuselage for final assembly. As the component approaches the fuselage, the magnets placed on both the OML of fuselage and the internal component itself begin to exert magnetic force on one another, pulling the component into precise alignment. This magnetic interaction, enabled by the precisely placed magnets from earlier steps, provide an automated, hands-free alignment mechanism, drawing the internal component securely into its designated location without requiring manual adjustments, fasteners, or clamps. This automatic positioning may be especially valuable in aerospace manufacturing, where even minor misalignments may impact structural integrity or aerodynamic performance. In an aspect, once the magnets have drawn the internal component into position, the mechanism for holding the internal component (e.g., a technician, an article of machinery, etc.) releases the internal component, allowing the magnetic forces to maintain the assembly without additional intervention. The adhesive may then be left to cure under the maintained pressure from the magnets, solidifying the bond between the internal component and the fuselage. In an aspect, the length of the curing period may be influenced by one or more factors, e.g., the size and/or type of the internal component, the type or thickness of the adhesive utilized, the number and/or strength of the magnets used, etc.

At step 145, after the adhesive has fully cured and the bond between the internal component and the fuselage is securely established, attention may turn to carefully removing the externally located magnets from the fuselage's OML. The external magnets have served their purpose of providing precise alignment and holding the internal component in place during the curing process, and now they must be removed to leave a clean, unobstructed exterior surface. In an aspect, the removal process may be carried out either manually or by using robotic arms equipped with soft-grip or non-abrasive tools that gently detach each magnet without disturbing the now-solidified bond line underneath. In an aspect, because the external magnets were affixed with temporary adhesive, they may be configured to peal away cleanly, ensuring that the fuselage remains unblemished and ready for any additional treatments or coatings that may follow. In an aspect, the cleared OML surface also prepares the fuselage for any final inspections or quality checks, which may be standard in aerospace manufacturing to ensure that all assembly requirements have been met.

Similarly to the foregoing, at step 150, following, or substantially during, the removal of the external magnets, the magnets from the internal component may be detached as well in the same or similar way that the external magnets were detached from the fuselage. Since these magnets were positioned to apply preload during curing, the adhesive bond should now have a consistent thickness and strength across the bonded area. In an aspect, with both the external and internal magnets removed, the bonded component stands as a fully integrated part of the fuselage, aligned precisely according to the CAD model specifications developed at the start of the process. In some aspects, the magnets from the internal component need not be removed and may remain permanently affixed to the internal component.

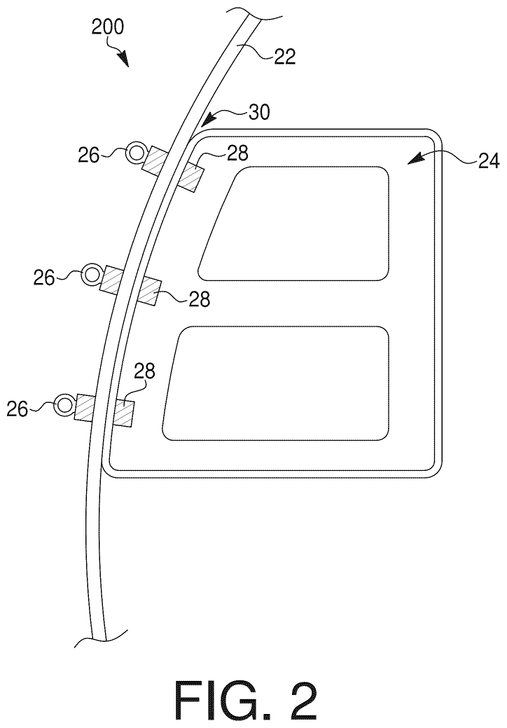

Referring now to FIG. 2, diagram 200 illustrates a schematic representation of the disclosed method 100 for assembling aircraft structures using neodymium rare earth magnets. Diagram 200 depicts a section of an aircraft fuselage skin 22 and an internal frame 24 (e.g., both composed of CFRP). A first set of magnets 26 may be strategically positioned on the OML of the fuselage skin 22, and a second set of magnets 28 may be positioned on the internal frame 24. In an aspect, the first set of magnets 26 and the second set of magnets 28 may be positioned along the bond line 30, which serves as the interface where the fuselage skin 22 and the internal frame 24 are bonded together. This bond line 30 represents the critical region for structural integrity, as it ensures a strong and precise connection between the components. The placement of the first set of magnets 26 and the second set of magnets 28 along the bond line ensures that the components are self-aligned during assembly, leveraging the magnetic force to provide the necessary preload for bonding. Diagram 200 illustrates an assembly assembled in accordance with the disclosed process discussed in reference to FIG. 1 by demonstrating how the first and second set of magnets 26, 28 guide and hold the components in position without the need for traditional fasteners or large-scale assembly tools.

In an aspect, an alternative implementation of this concept leverages robotic automation to enhance the precision, efficiency, and scalability of the assembly process. More particularly, instead of using overhead laser projection systems to manually position the magnets on the OML surface of the parent component, a robotic arm (e.g., a 6-axis robotic arm, etc.) may be employed to accurately locate and attach the magnets. This robotic implementation offers improved precision in magnet placement, as the robot's advanced control systems may allow for sub-millimeter accuracy, ensuring that the magnets are aligned with the predefined positions specified in the CAD model.

In addition to placing magnets on the OML, CNC-controlled robotic arms may be used in manufacturing preparation cells to attach corresponding magnets to the mating components, such as internal frames. This automates a step that would otherwise require manual intervention, thereby reducing human error and accelerating the process. In an aspect, these robotic systems may also perform other important tasks in the assembly process, such as preparing bonding interfaces by cleaning, applying surface treatments, or controlling bond line thickness. Robots equipped with adhesive applicators may precisely dispense bonding material, ensuring consistent application and minimizing waste. In an aspect, once the magnets are in place and the bonding material has been applied, the robotic arm may position the mating component near the parent structure. The magnetic forces between the pre-set magnets automatically align the parts, applying the necessary preload to facilitate bonding. This eliminates the need for large and cumbersome assembly tools, freeing up available space on the factory floor. In an aspect, the robotic arm, having completed the positioning task, may immediately retract and move to the next component, thereby improving assembly throughput.

Ultimately, the utilization of robotics in the processes described herein may eliminate large assembly fixtures and enable greater accessibility for robotic arms, which enhances flexibility and scalability. This setup is especially advantageous for complex aircraft structures, where space constraints and precision requirements may otherwise hinder automation. Overall, this robotic alternative reduces cycle times, improves accuracy, and enhances the adaptability of the assembly process while maintaining the reliability and structural integrity required for aircraft manufacturing.

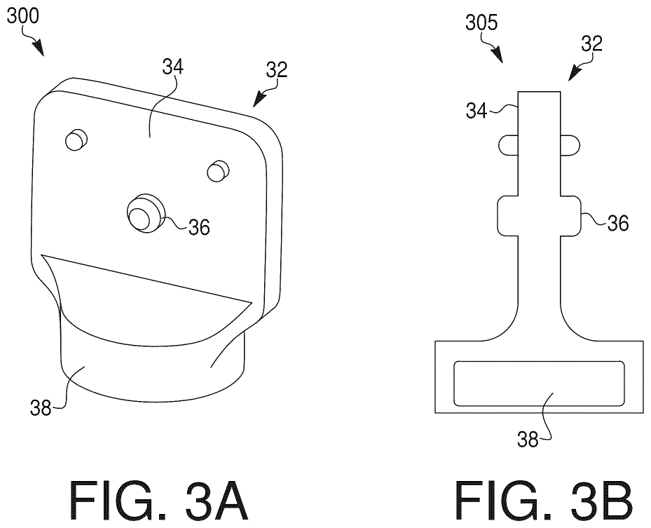

FIGS. 3A and 3B collectively illustrate a magnet assembly 32 designed for robotic automation in the placement and utilization of magnets for aircraft assembly. The magnet assembly 32 may include an engagement pad 34, robotic arm index nodes 36, and enclosed magnets 38. Collectively, these components enable a 6-axis robotic arm to precisely place the magnets on the OML surface or on the mating components in manufacturing preparation cells.

In an aspect, the engagement pad 34 may serve as the interface between the magnet assembly 32 and a robotic arm (not illustrated), providing a stable and reliable point of contact for the robotic arm to grip, manipulate, and position the magnet assembly 32 accurately. This design may allow the robotic arm to securely engage the housing of the magnet assembly 32 during transport and placement. In an aspect, the engagement pad's 34 surface may include features such as texture, grooves, or mechanical connections to ensure a firm and repeatable interaction with the end of the robotic arm. In an aspect, the robotic arm index nodes 36 may work in tandem with the engagement pad 34, offering secondary or auxiliary points of contact for alignment and stability during robotic manipulation. Together, these features may ensure that the magnet assembly 32 is correctly oriented and precisely positioned during placement on the OML or mating component. In an aspect, the enclosed magnets 38 may be encapsulated within a housing of the magnet assembly 32 to protect it from environmental damage and ensure precise functionality. This encapsulation allows the magnet to exert its magnetic force while being securely housed in a durable material, which is important for maintain reliability during automated operations.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for assembling a vehicle, comprising:
applying a first set of magnets to a first set of predefined positions on a first surface of a first structural component of the vehicle;
applying a second set of magnets to a second set of predefined positions on a first surface of a second structural component of the vehicle;
preparing a second surface of the first structural component, opposite the first surface of the first structural component, for bonding the first structural component of the vehicle to the second structural component of the vehicle;
applying a bonding material to the prepared second surface of the first structural component;
positioning a second surface of the second structural component against the applied bonding material on the prepared second surface of the first structural component, wherein the second structural component is secured against the first structural component via a magnetic attraction formed between the first set of magnets and the second set of magnets; and
removing, after a predetermined cure time associated with the bonding material, the first set of magnets from the first surface of the first structural component and the second set of magnets from the first surface of the second structural component.

2. The method of claim 1, wherein the vehicle is an aircraft.

3. The method of claim 1, wherein the vehicle is an aircraft, and wherein the aircraft is an electric vertical take-off and landing (eVTOL) vehicle.

4. The method of claim 1, wherein the first set of predefined positions and the second set of predefined positions are determined using a computer-aided design (CAD) model.

5. The method of claim 1, wherein the first set of predefined positions and the second set of predefined positions are determined using a computer-aided design (CAD) model, and wherein the method further comprises:
projecting at least the first set of predefined positions onto the first surface of the first structural component.

6. The method of claim 1, wherein the first set of magnets and the second set of magnets are neodymium rare earth magnets.

7. The method of claim 1, wherein the first structural component is a fuselage.

8. The method of claim 1, wherein the second structural component is an internal component of the vehicle.

9. The method of claim 1, wherein the second structural component is an internal component of the vehicle, and wherein the internal component is one of a frame or a stringer.

10. The method of claim 1, wherein the bonding material is an adhesive formulated to cure to a predetermined thickness.

11. The method of claim 1, wherein the applying the bonding material comprises controlling a thickness of the bonding material by leveraging applying the bonding material leveraging one or more bond line thickness control measures.

12. The method of claim 1, wherein the applying the bonding material comprises applying the bonding material leveraging one or more bond line thickness control measures, wherein the one or more bond line thickness control measures include at least one of a pre-placed spacer, a controlled adhesive applicator, or a bond line control film.

13. A magnet assembly, comprising:
a first portion including a first surface and a second surface, the second surface positioned opposite the first surface;
each of the first surface and the second surface, including:
an engagement pad positioned proximate to a first end of the first portion; and
one or more protruding nodes;
a second portion connected to a second end of the first portion; and
a magnet encased within a housing of the second portion.

14. The magnet assembly of claim 13, wherein the engagement pad comprises at least one of a textured surface, grooves, or a mechanical connection.

15. The magnet assembly of claim 13, wherein the magnet is a neodymium rare earth magnet.

16. A method for assembling a vehicle, comprising:
placing a first set of magnets at a first set of predefined positions on a first surface of a first structural component of the vehicle utilizing at least one robotic component;
placing a second set of magnets at a second set of predefined positions on a first surface of a second structural component of the vehicle utilizing at least one robotic component;
preparing, with the at least one robotic component, a bonding surface for bonding the first structural component of the aircraft to the second structural component of the vehicle;
distributing, using the at least one robotic component, an adhesive along the bonding surface; and
positioning, using the at least one robotic component, the second structural component against the bonding surface such that magnetic forces align the first structural component with the second structural component.

17. The method of claim 16, wherein the robotic component is a 6-axis robotic arm.

18. The method of claim 16, wherein the distributing the adhesive comprises distributing via an adhesive applicator integrated into the at least one robotic component.

19. The method of claim 16, further comprising causing the at least one robotic component to retract after positioning the second structural component against the bonding surface.

20. The method of claim 16, wherein each of the first set of magnets and the second set of magnets contain an engagement surface, and one or more index nodes configured to provide a point of contact for the at least one robotic component.
